(19) United States
(12) Patent Application Publication
(10) Pub. No.: US 2021/0238856 A1
(43) Pub. Date: Aug. 5, 2021

(54) APPARATUS AND METHOD FOR HARD MOUNTING EQUIPMENT TO A MOUNTING CURB

(71) Applicant: Catalyst Acoustics Group, Inc., Agawam, MA (US)

(72) Inventors: Thomas Yuschak, Lewis Center, OH (US); Paul Selman, Oak Forest, OH (US); Lee Chiddention, Johnstown, OH (US)

(73) Assignee: Catalyst Acoustics Group, Inc., Agawam, MA (US)

(21) Appl. No.: 17/163,360

(22) Filed: Jan. 30, 2021

Related U.S. Application Data
(60) Provisional application No. 62/968,673, filed on Jan. 31, 2020.

(51) Int. Cl. E04D 13/00; F16M 13/02

(52) U.S. Cl. CPC E04D 13/00; F16M 13/02

(57) ABSTRACT

When hard mounting equipment having a base flange to a curb, a mounting method provides a relatively s-shaped restraint bracket shaped to fit over the top of the curb, and the bottom of the base flange, and having thru holes lined up perpendicularly to the bracket. This bracket is then mounted to the curb, and mounting holes are then drilled through the curb at the bracket thru hole location. The mechanical equipment is then placed on the curb, such that the base flange sits in the restraint bracket, and holes are drilled through the base flange at the location of the restraint bracket thru holes. A restraint bolt is then inserted through the holes and tightened in place.

This application claims the benefit of U.S. Provisional Application No. 62/968,673 filed Jan. 31, 2020.

### BACKGROUND

The present invention is in the field of mechanical equipment mounting. More specifically this invention relates to mounting mechanical equipment to a roof curb.

### BRIEF DESCRIPTION OF DRAWINGS

FIG. 1 is a cross sectional view of mechanical equipment mounted to a curb according to an aspect of the invention.

FIG. 2 is an isometric view of the restraint bracket according to an aspect of the invention.

FIG. 3 is an isometric view of a curb.

FIG. 4 is a cross sectional view of the restraint bracket according to an aspect of the invention.

FIG. 5 is a cross sectional view of mechanical equipment mounted to a curb according to an aspect of the invention.

FIG. 6 is a drawing of a T-anchor bolt as used in an aspect of the invention.

### DETAILED DESCRIPTION

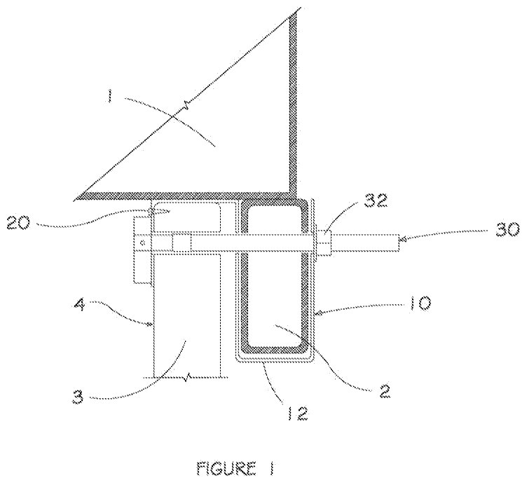

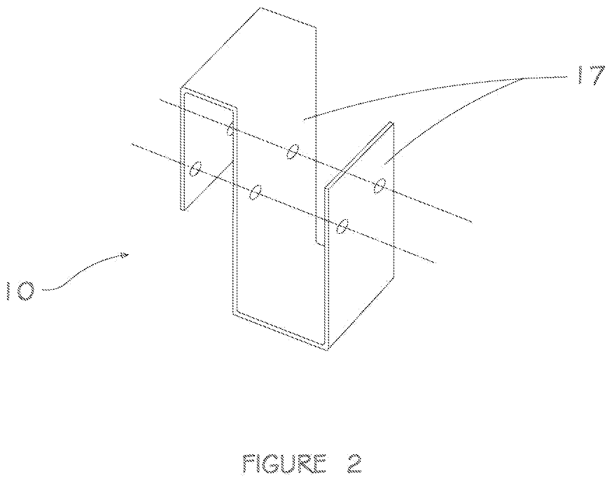

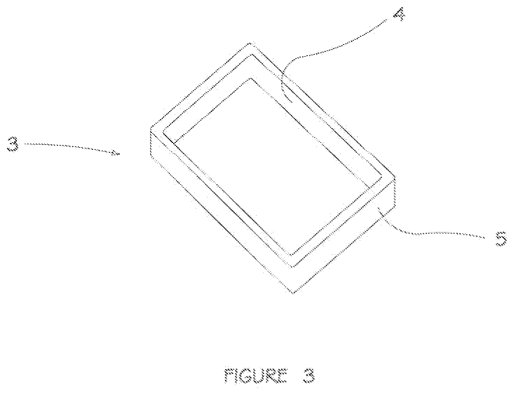

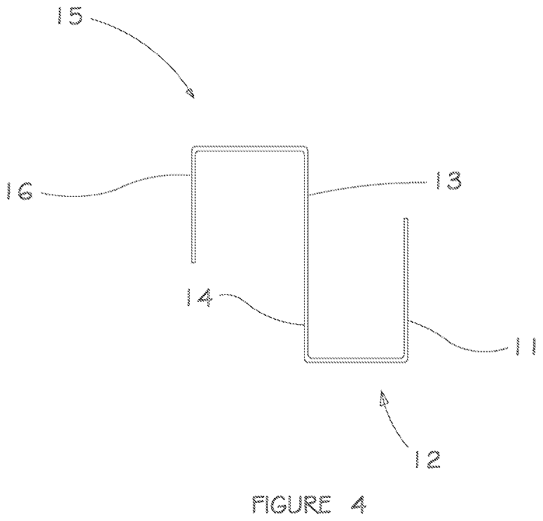

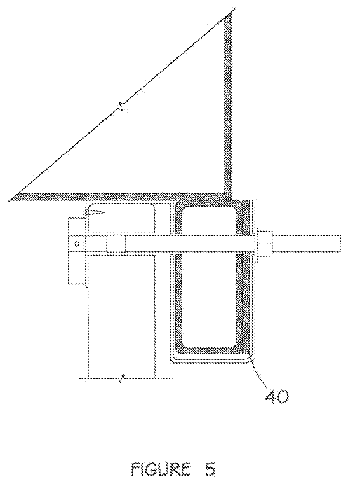

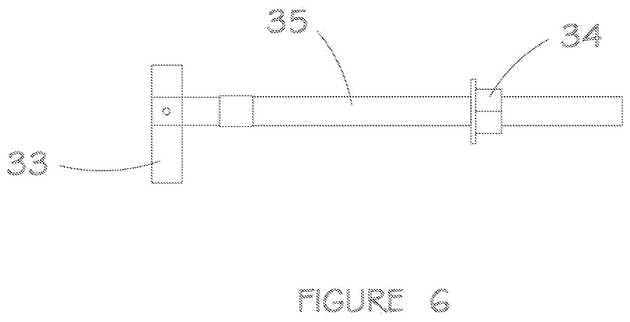

Various aspects of the invention are presented in FIGS. 1-6 which are not drawn to scale. Referring now to these figures, according to an aspect of the invention, a method for hard mounting mechanical equipment, having a base flange, to a curb is shown.

When mechanical equipment is mounted on a roof, or other surface, it is common practice to attach a curb 3, having an inner perimeter 4 and an outer perimeter 5, to the mounting surface, and then mount the equipment to the curb. This is done because it is often difficult to mount the equipment directly to the mounting surface. When being mounted to a curb, the equipment typically has a base flange 2. This base flange is sized such that when seated on the curb, the base flange is adjacent to the curb outer perimeter. When the equipment is seated on the curb in this manner, the base flange keeps the equipment generally in place, but there is still the possibility of lateral and vertical movement due to vibration of the equipment, wind, or other factors. To restrain or eliminate these motions, a hard mount is needed.

According to an aspect of the invention, the mounting method comprises the steps of providing a restraint bracket 10; mounting the restraint bracket 10 to the curb 3; drilling mounting holes through the curb 3; placing the mechanical equipment 1 on the curb 3; drilling holes through the base flange 2; inserting a restraint bolt 30 through the holes; and tightening the restraint bolt 30 in place.

The restraint bracket 10 provided has a front side 12 and a back side 15. The front side 12 is shaped like a U-bracket, having a front leg 11 and a back leg 13. The back side 15 is shaped like an upside-down U-bracket, having a front leg 14 and a back leg 16, and the front side back leg 13 is also the back side front leg 14. The restraint bracket 10 has at least one set of thru holes 17, wherein a set of thru holes comprises a thru hole in each leg of the restraint bracket 10. The set of thru holes 17 are aligned such that a bolt can be inserted through all 3 holes at the same time, and when a bolt is installed in the restraint bracket through these holes, the bolt will be perpendicular to each leg.

The restraint bracket back side 15 is seated over the curb 3, such that the restraint bracket front side 12 is on the curb outer perimeter 5. The restraint bracket 10 is then mounted to the curb 3 using a mounting means 20. A hole is then drilled through the curb 3 at the location of the restraint bracket thru holes 17.

The mechanical equipment 1 is then placed on the curb 3, such that the mechanical equipment base flange 2 seats in the restraint bracket front side 15.

A hole is then drilled through the mechanical equipment base flange 2 at the location of the thru holes 17.

A restraint bolt 30 having a head 33, a bolt portion 35, and an opposing locking means 32 is then inserted through all thru holes head 33 first, from said restraint bracket front side front leg 11, through the base flange 2, restraint bracket 13/14, curb 3, and finally through said restraint bracket back side back leg 16, such that the locking means 32 is outside of restraint bracket front side front leg 11, and the head 33 is completely through the restraint bracket back side back leg 16. The locking means 32 is then engaged.

According to an aspect of the invention, the restraint bolt 30 is a toggle bolt wherein the head is a toggle nut with collapsible wings, and the locking means is a nut. In this aspect, the thru holes are sized to fit the collapsed wings.

In a preferred embodiment, the restraint bolt 30 is a T-anchor, wherein the head 33 is a gravity activated toggle, and wherein the locking means 32, is a nut 34. With a T-anchor the thru holes 17 can be sized smaller, allowing less play between the bolt 30 and the thru holes. When the T-anchor is pushed through the thru holes, the head 33 will flip to be perpendicular to the bolt portion 35, and the nut 34 is then tightened until the bolt 30 is secured.

According to a further aspect of the invention, the mounting method further comprises the step of providing an isolation pad 40 between the restraint bracket, 10 and the base flange 2. This isolation pad can be placed between horizontal faces, between the vertical faces, or both. The isolation pad 40 may be an elastomeric material, or any other isolating material.

I claim:

1. A method for hard mounting mechanical equipment having a base flange, to a curb, wherein the curb has an inner perimeter and an outer perimeter, comprising the steps:
Providing a restraint bracket, wherein said restraint bracket has a front side and a back side, wherein said front side is shaped like a U-bracket, having a front leg and a back leg; and wherein said back side is shaped like an upside down U-bracket, having a front leg and a back leg, and wherein said front side back leg is also said back side front leg; wherein said restraint bracket has at least one set of thru holes, wherein a set of thru holes comprises a thru hole in each leg of said restraint bracket, wherein said thru holes are aligned such that a bolt can be slid through all 3 holes at the same time, and when a bolt is installed in said restraint bracket through these holes, the bolt will be perpendicular to each leg;
Placing said restraint bracket back side over the curb, such that said restraint bracket front side is on the curb outer perimeter;
Mounting said restraint bracket back side to the curb using a mounting means;
Drilling a hole through the curb at the location of said thru holes;
Placing the mechanical equipment on the curb, such that the mechanical equipment base flange seats in said restraint bracket front side;
Drilling a hole through the mechanical equipment base flange at the location of said thru holes;
Inserting a restraint bolt having a head, a bolt portion, and an opposing locking means through all thru holes, said head first, from said restraint bracket front side front leg, through the base flange, restraint bracket, curb, and finally through said restraint bracket back side back leg, such that said locking means is outside of said restraint bracket front side front leg, and said head is completely through said restraint bracket back side back leg; and
Engaging said locking means.

2. The method of claim 1 wherein said restraint bolt is a toggle bolt, wherein said head has a toggle nut with collapsible wings, wherein said thru holes are sized to fit said collapsed wings, and wherein said locking means is a nut.

3. The method of claim 1 wherein said restraint bolt is a T-anchor wherein said head is a gravity activated toggle, wherein said locking means, is a nut.

4. The method of claim 1 further comprising the step of providing an isolation pad between said restraint bracket, and the mechanical equipment base flange.

5. The method of claim 4 wherein said isolation pad is an elastomeric material.
